(19) United States
(12) Patent Application Publication
(10) Pub. No.: US 2025/0215744 A1
(43) Pub. Date: Jul. 3, 2025

(54) BREATHABLE WINDOW RETROFIT SYSTEM FOR BUILDINGS

(71) Applicant: INOVUES, INC., Houston, TX (US)

(72) Inventors: Anas Al Kassas, Houston, TX (US); Paul Griese, Durham, CT (US)

(21) Appl. No.: 19/015,937

(22) Filed: Jan. 10, 2025

Related U.S. Application Data
(63) Continuation of application No. PCT/US2023/027688, filed on Jul. 13, 2023.
(60) Provisional application No. 63/419,312, filed on Oct. 25, 2022.
(60) Provisional application No. 63/389,351, filed on Jul. 14, 2022.

(51) Int. Cl. E06B 7/10; E06B 7/02; E06B 7/23

(52) U.S. Cl. CPC E06B 7/10; E06B 7/23; E06B 2007/026

(57) ABSTRACT

In various embodiments, there is described herein a breathable system for retrofitting an existing window, comprising: a secondary infill glazing panel adapted to be positioned adjacent to an existing glazing panel to form an interior cavity between the existing glazing panel and the secondary glazing panel, a frame enclosing exterior edges of the secondary infill panel, and at least one air permeable filter coupled to the frame adapted to allow an air flow between the interior cavity and an exterior space adjacent to the secondary glazing panel.

### CROSS REFERENCE TO RELATED APPLICATIONS

This application is a Continuation of International Application No. PCT/US2023/027688, filed Jul. 13, 2023, entitled “BREATHABLE WINDOW RETROFIT SYSTEM FOR BUILDINGS,” which claims the benefit of the filing dates of U.S. Provisional Patent Application No. 63/389,351, filed on Jul. 14, 2022, entitled “VENTILATED SYSTEM FOR RETROFITTING GLAZING SYSTEMS OF BUILDING” and U.S. Provisional Patent Application No. 63/419,312, filed on Oct. 25, 2022, entitled “VENTILATED SYSTEM FOR RETROFITTING GLAZING SYSTEMS OF BUILDING,” the disclosures of which are incorporated herein by reference for all purposes.

### TECHNICAL FIELD

The invention relates in general to providing secondary windows to existing framed glass systems and in particular to breathable secondary window or window retrofit systems for buildings and other structures.

### BACKGROUND INFORMATION

Buildings are very significant end users of energy. They are responsible for about 40% of all energy consumption and the resulting carbon emissions world-wide in both developed and developing countries. One of the main reasons for the large portion of energy consumption is that the majority of the existing building stock is over 20 years old. Thus, most buildings have poorly-performing and inefficient building systems compared to newly constructed buildings using current system technologies. The very significant use of energy by the building envelope, is directly related to thermal performance and weather tightness, which determine the amount of energy a building needs to maintain a comfortable indoor environment separated from the outdoors.

Up until the 1980s, windows, curtain walls, and skylights were typically single-glazed with frameworks that had high thermal conductance. These inefficient glazing systems result in significant heat loss in the winter and heat gain in the summer, and thus, lead to higher energy consumption, respectively, for heating and cooling to maintain a comfortable indoor environment.

In general, a secondary window can be described as an assembly that is added to an existing window in a building which increases the energy efficiency of the existing window in some way. In some instances, a secondary window can be placed adjacent to the original or existing window, and thereby creates an insulating air cavity which results in greater energy efficiencies than from the existing or original window alone.

Because of its nature and position near the original or existing window, a secondary window on the inside of a building blocks much of the thermal energy transfer from the building to the existing window. When the outdoor climate is cool, or the emittance of heat to the night sky is significant, the result can be a reduction of the temperature of the existing window, as well as the air and surfaces in the cavity that has been created by the secondary window. When interior air of the cavity is laden with water vapor, commonly referred to as humidity, and it reaches the surfaces forming the cavity which are at temperatures below the dewpoint, the water vapor changes its phase to liquid water, or even to its solid-phase, frost or ice. This water phase-changing is also commonly known as condensation or fogging. Condensation is undesirable for reasons of appearance, cleanliness, and potential for mold to form and damage the window or surrounding building materials.

Furthermore, such closed cavities and the tight seal around them can create elevated temperatures within the cavity while trapping moisture in the air. This can result in persistent condensation and excessive heat build-up within the cavity, which in turn increases the risk of glass breakage due to thermal stress.

Therefore, there is a need for secondary window systems which can increase the efficiency of existing window systems while mitigating condensation and other disadvantages of conventional secondary window systems.

### SUMMARY

In response to these and other problems, in one embodiment, there is described a breathable system for retrofitting an existing window that can passively vent without letting in dust, which helps eliminate any excessive heat-build or persistent condensation within the cavity. This “breathable” retrofit system comprising: a secondary infill glazing panel adapted to be positioned adjacent to an existing glazing panel to form an interior cavity between the existing glazing panel and the secondary glazing panel, a frame enclosing exterior edges of the secondary infill panel, and at least one air permeable filter coupled to the frame adapted to allow an air flow between the interior cavity and an exterior space adjacent to the secondary glazing panel.

In other embodiments, the frame comprises a plurality of frame members forming a U-shaped retaining slot for retaining a perimeter portion of the edge of the secondary infill panel.

In other embodiments, a dimension of the frame is sized to allow the air flow from the interior cavity through the at least one air permeable filter to the exterior air space.

In other embodiments, the frame comprises a plurality of frame members each having longitudinal engagement slots to receive a leg of a corner key which is used to partially join the frame members together to form the frame.

Other embodiments may also comprise a second air permeable filter coupled to the frame to allow a second air flow between the interior cavity and the exterior space adjacent to the secondary glazing panel.

In other embodiments, the at least one air permeable filter is positioned through the frame.

In other embodiments, the at least one air permeable filter is positioned in proximity with a bottom of the frame and a second air permeable filter is positioned in proximity with a top of the frame.

In other embodiments, the at least one air permeable filter is coupled to a sill element of the frame and a second air permeable filter is coupled to a header element of the frame.

Other embodiments may also comprise at least one retainer coupled to an existing window frame element which partially retains at least one frame member of the frame.

Other embodiments may also comprise at least one retainer coupled to an existing window frame element enclosing the at least one air permeable filter and a portion of the frame.

Other embodiments may also comprise a means for sealing at least one air gap between existing window frame elements and the frame so that the air flow occurs through the at least one air permeable filter.

Other embodiments may also comprise a means for sealing at least one air gap between the existing glazing panel and the secondary glazing panel so that the air flow occurs through the at least one air permeable filter.

In other embodiments, the at least one means for sealing is a gasket coupled to an indent defined in the outside facing surface of the frame.

Other embodiments may also comprise a sealing gasket coupled to a frame member adapted to form a seal between the frame member and a corner of an existing window frame element.

In other embodiments, at least one frame member defines a perimeter slot for coupling to a cosmetic gasket.

Other embodiments may also comprise at least one frame member defining a perimeter slot for coupling to a sealing gasket.

Other embodiments may also comprise a means for attaching to an existing element which is positioned on an exterior facing surface of at least one frame member and adapted to adhere to an interior facing surface of an existing window frame.

Other embodiments may also comprise a means for attaching to an existing element which is positioned on an exterior facing surface of at least one frame member and the means for attaching is adapted to adhere to an interior facing surface of the existing infill panel.

Other embodiments may also comprise a means for attaching to an existing element which is positioned on an exterior facing surface of at least one polymeric spacer coupled to an exterior facing surface of a frame member and the means for attaching is adapted to adhere to an interior facing surface of an existing infill panel.

In other embodiments, the means for attaching is a pair of reclosable mounting strips where one mounting strip is coupled to the outside facing surface of the frame and a matching mounting strip is coupled to the inside facing surface of an existing window frame.

In other embodiments, the means for attaching is a pair of reclosable mounting strips where one mounting strip is coupled to the outside facing surface of the frame and a matching mounting strip is coupled to the inside facing surface of an existing window.

In other embodiments, the means for attaching is a gasket positioned around the perimeter of the frame and sized to create a frictional retainage between the frame and the surrounding window elements.

In other embodiments, the means for attaching is a flexible attachment system which does not limit thermal expansion of the separate members of the system.

Other embodiments may also comprise intermediate framing members positioned in proximity to a perimeter of the existing window and a means for attaching the frame to the intermediate framing members.

Other embodiments may also comprise a smart system, the smart system comprising: a controller comprising: a processor, a memory in communication with the processor, a power management circuit in communication with the processor, a radio in communication with the controller for receiving operation instructions and transmitting status information, and an energy storage device in communication with the processor, a substantially clear photovoltaic cell coupled to the infill panel and electronically coupled to the power management circuit and the energy storage device.

Other embodiments may also comprise a smart system, further comprising an electrochromic conductive layer coupled to the infill panel and in electric communication with the processor.

Other embodiments may also comprise a method of installing a secondary window system to an existing glazing panel, the method comprising: positioning a frame enclosing a perimeter of a secondary glazing panel adjacent to an existing glazing panel to form an interior cavity between the existing glazing panel and the secondary glazing panel, and positioning at least one air permeable filter adjacent to the interior cavity to allow an air flow between the interior cavity and an exterior space adjacent to the secondary glazing panel.

Other embodiments of the method described above may also comprise positioning a second air permeable filter adjacent to the interior cavity to allow a second air flow between the interior cavity and the exterior space adjacent to the secondary glazing panel.

Other embodiments of the method described above may also comprise positioning the at least one air permeable filter in proximity with a bottom of the frame and positioning a second air permeable filter in proximity with a top of the frame.

Other embodiments of the method described above may also comprise coupling the at least one air permeable filter to a sill element of the frame and coupling a second air permeable filter to a header element of the frame.

Other embodiments of the method described above may also comprise coupling at least one retainer to an existing window frame element to partially retain at least one frame member of the frame.

Other embodiments of the method described above may also comprise sealing at least one air gap between existing window frame elements and the frame so that the air flow occurs through the at least one air permeable filter.

Other embodiments of the method described above may also comprise sealing at least one air gap between the existing glazing panel and the secondary glazing panel so that the air flow occurs through the at least one air permeable filter.

Other embodiments of the method described above may also comprise sealing a cosmetic gasket to at least one frame member of the frame.

Other embodiments of the method described above may also comprise attaching at least one frame member of the frame to an interior facing surface of an existing window frame element.

Other embodiments of the method described above may also comprise attaching at least one frame member of the frame to an interior facing surface the existing infill panel.

Other embodiments of the method described above includes mounting one strip of a pair of reclosable mounting strips to the outside facing surface of the frame and a mounting a matching mounting strip to the inside facing surface of an existing window frame element.

Other embodiments of the method described above includes mounting one strip of a pair of reclosable mounting strips to the outside facing surface of the frame and a mounting a matching mounting strip to the inside facing surface of an existing infill panel.

Other embodiments of the method described above may also comprise positioning a gasket around the perimeter of the frame to create a frictional retainage between the frame and the surrounding window elements.

Other embodiments of the method described above may also comprise flexibly attaching the frame so not to limit thermal expansion of the separate members of the system.

Other embodiments of the method described above may also comprise positioning intermediate framing members in proximity to a perimeter of the existing window and attaching the frame to the intermediate framing members.

These and other features, and advantages, will be more clearly understood from the following detailed description taken in conjunction with the accompanying drawings. It is important to note the drawings are not intended to represent the only aspect of the invention.

### BRIEF DESCRIPTION OF THE DRAWINGS

FIG. 1 is an isometric drawing illustrating a portion of an exemplary existing glazed curtain wall system.

FIG. 1 A-A illustrates a vertical section view of a typical existing window or infill panel illustrated in FIG. 1.

FIG. 1 B-B illustrates a horizontal section view of the existing window illustrated in FIG. 1.

FIG. 2A is a vertical section drawing illustrating one embodiment of a secondary window system mounted next to an existing window system.

FIG. 2B is a horizontal section drawing illustrating the embodiment of a secondary window system illustrated in FIG. 2A mounted next to an existing window system.

FIG. 3A is a vertical section drawing illustrating an alternative embodiment of a secondary window system mounted next to an existing window system.

FIG. 3B is a horizontal section drawing illustrating the alternative embodiment of a secondary window system illustrated in FIG. 3A mounted next to an existing window system.

FIG. 4A is a vertical section drawing illustrating an alternative embodiment of a secondary window system mounted next to an existing window system.

FIG. 4B is a horizontal section drawing illustrating the alternative embodiment of a secondary window system illustrated in FIG. 4A mounted next to an existing window system.

FIG. 5A is an overview of a conceptual functional diagram of certain electronics and sensors that could be incorporated into the various embodiments of the invention.

FIG. 5B is a detailed conceptual functional diagram of certain electronics and sensors that could be incorporated into the various embodiments of the invention.

### DETAILED DESCRIPTION

For the purposes of promoting an understanding of the principles of the present inventions, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the inventions as described herein are contemplated as would normally occur to one skilled in the art to which the invention relates.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When directions, such as upper, lower, top, bottom, clockwise, counter-clockwise, are discussed in this disclosure, such directions are meant to only supply reference directions for the illustrated figures and for orientation of components in the figures. The directions should not be read to imply actual directions used in any resulting invention or actual use. Under no circumstances, should such directions be read to limit or impart any meaning into the claims.

Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

### An Existing Window System

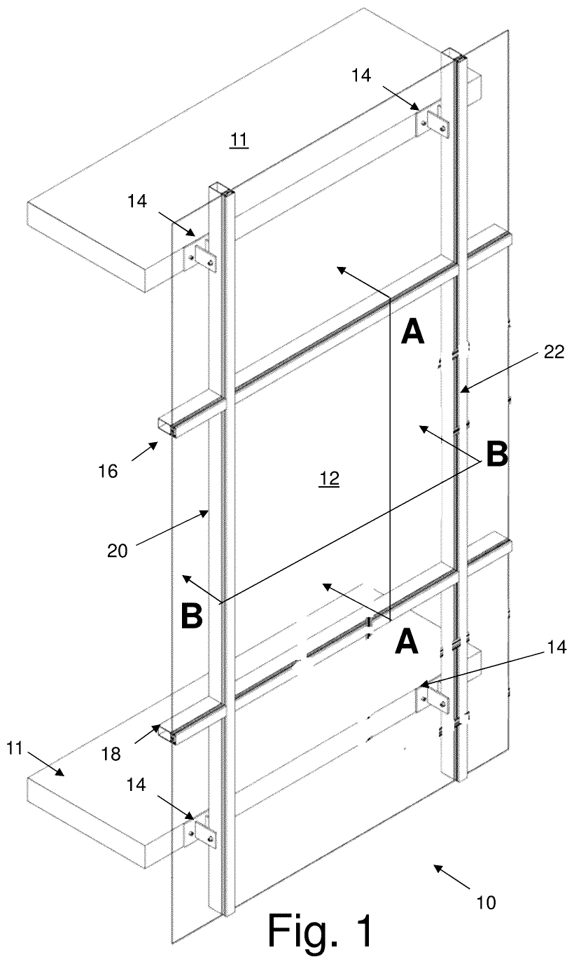

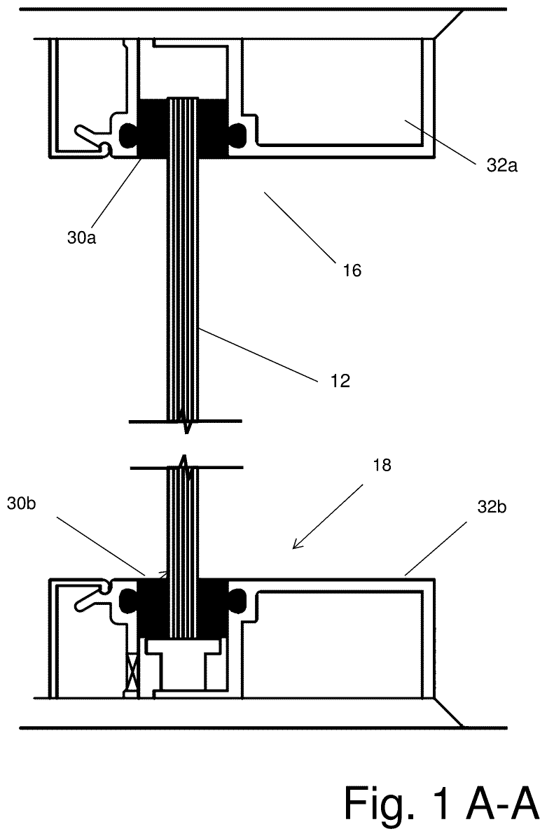

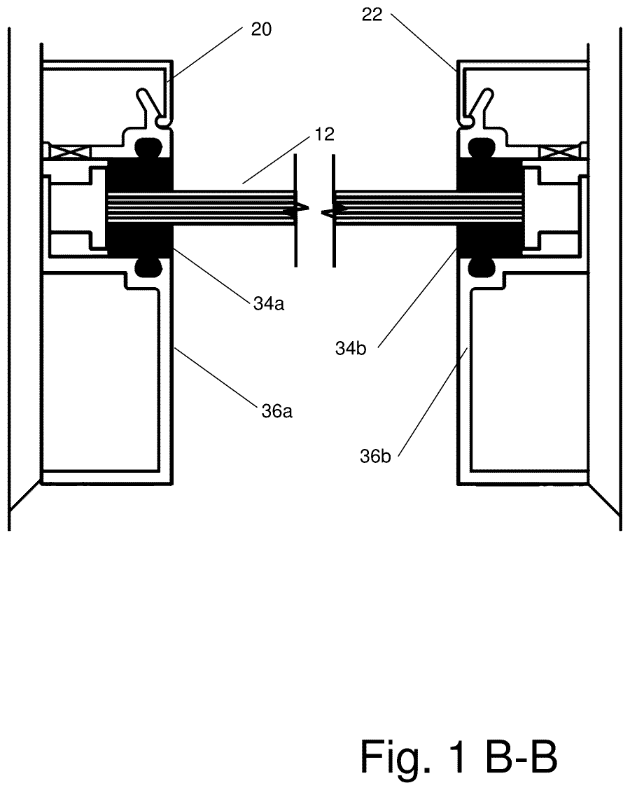

FIG. 1 is an isometric drawing illustrating a portion of an exemplary existing glazed curtain wall system 10. In the illustrated embodiment, the existing glazing system 10 may be known as a mechanically-glazed, stick-built curtain-wall system, which typically comprises anchor assemblies 14, vertical mullion assemblies 20 and 22 (which are equivalent to side jamb elements), horizontal mullion assemblies 16 and 18 (which are equivalent to jamb elements, head elements and sill elements, respectively, for window framing system), and an existing “window” or infill panel 12. The anchor assemblies 14 are typically attached to the building structure 11, such as concrete floor decks, and are used to transfer the weight, wind and other imposed forces from the stick-built curtain-wall to the building structure. Although the exemplary system of FIG. 1 is illustrated as a curtain wall system, the existing systems described herein are not limited to glass curtain wall systems. In fact, the existing systems may be any building wall opening having an existing window, transparent, or translucent panel.

FIG. 1A-A illustrates a vertical section view of a typical existing window or infill panel 12 wherein the upper portion of the panel 12 is coupled to various existing window frame elements. The illustrated existing window framing elements may include a head element 16 and a lower portion of the infill panel 12 is coupled to a sill element 18. Because details of existing head elements and sills vary widely, such details will not be discussed in depth here. Furthermore, the term “existing window framing elements” can refer to any element supporting or surrounding an existing window or panel as is known in the art. As illustrated in FIG. 1A-A, the head element 16 may be coupled to the panel 12 via an attachment means such as a gasket 30a. The gasket 30a couples to a frame assembly 32a of the head element 16. Similarly, the lower portion of the infill panel 12 may be coupled to a frame assembly 32b of the sill element 18 via a gasket 30b. In certain embodiments, the frame assemblies 32a and 32b may be part of a mullion system for a curtain wall covering a large façade, or directly couple to a building structure forming a window opening.

In contrast, FIG. 1 B-B illustrates a horizontal section view of the existing panel 12 coupled to a first existing side jamb element 20 and the second existing side jamb element 22. In certain embodiments, some form of seal or gaskets 34a and 34b may positioned to secure the existing panel 12 between the frame assemblies 36a and 36b of the side jamb elements 20 and 22, respectively.

The existing infill panels or windows 12 may be any type of transparent glass, opaque spandrel glass, or translucent glass infill panel. In certain embodiments, the existing panels 12 may be any type of monolithic, laminated, double-, triple-, or multi-pane panel of any configuration, or any other type of glass infill panel.

The existing glazing system 10, shown in FIGS. 1, 1A-A, and 1B-B is exemplary only and is not intended to limit the scope of the invention in any way. The present invention may readily be used with a wide variety of new and existing glazing systems including, but not limited to, single-, double-, or multi-pane glazing systems, mechanically-captured or structural silicone-glazed systems, point-fixed glazing systems, stick-built and pre-fabricated unitized curtain-walls, window-walls, strip and ribbon windows, fixed and operable window sashes, storefront, doors, skylights, sloped glazing, and the like.

### Overview of the Secondary Window Retrofit:

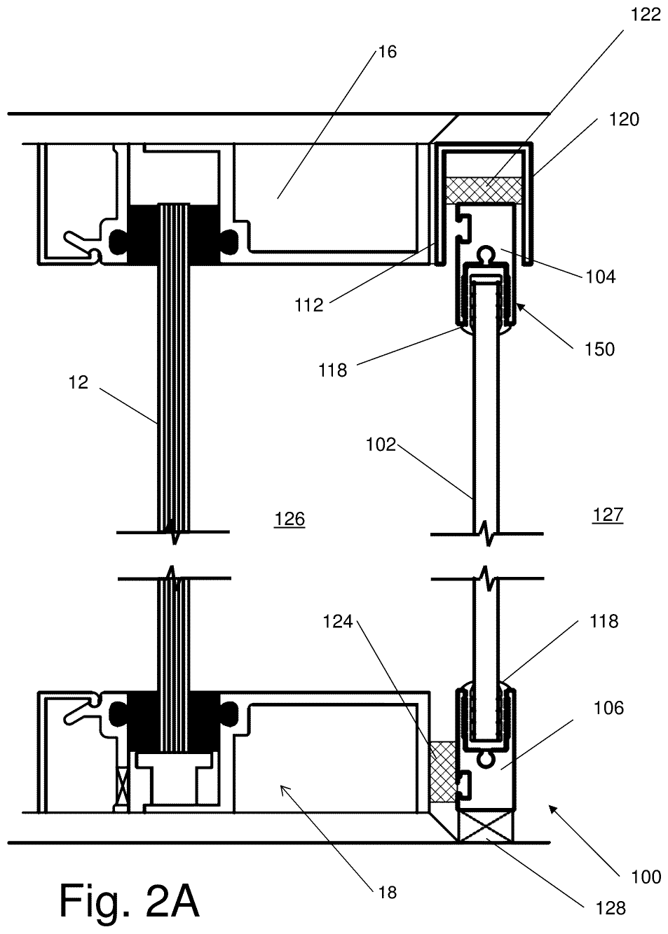

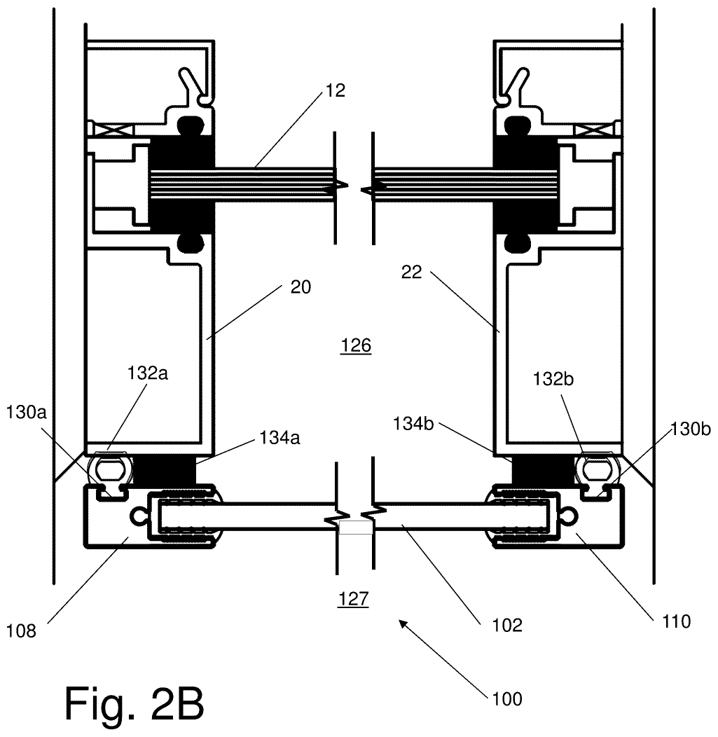

FIG. 2A is a vertical section drawing illustrating one embodiment of a breathable window retrofit system 100 mounted next to an existing window or glazing panel 12. Similarly, FIG. 2B is a horizontal section drawing illustrating one embodiment of the breathable window retrofit system 100 mounted next to the existing window or glazing panel 12. As discussed above, the existing window or glazing panel 12 may be supported or surrounded by a variety of existing window frame elements, such as the existing head jamb element 16 and the existing sill element 18. A secondary window or secondary infill glazing panel 102 may be positioned adjacent to the existing glazing panel 12 to form an interior cavity 126 between the existing glazing panel and the secondary glazing panel 102. In certain embodiments, a frame 150 encloses the edges of the secondary infill panel 102 as illustrated in FIGS. 2A and 2B. A first air permeable filter, such as a lower air permeable filter 124 may be positioned between the lower portion of the existing window 12 and the lower portion of the frame 150 to create a passage for air to flow from the cavity 126 into the space 127 on the exterior of the cavity 126 (or vice versa). Similarly, in some embodiments, a second air permeable filter, such as an upper air permeable filter 122 may be positioned in proximity to the upper portion of the existing window 12 and the upper portion of the frame 150 to create a second passage for air to flow from the cavity 126 into the space 127 on the exterior of the cavity 126 (or vice versa). Although two air permeable filters are illustrated in FIG. 2A, any number of air permeable filters may be used depending on the specific considerations of the existing window and building. In certain embodiments, air passages that do not have an air permeable filter are sealed with a sealing means to prevent air flow between the cavity 126 and the exterior space 127 except through air permeable filters.

### The Panel Member:

The infill panel 102 (and panels 202 and 302 discussed later) may be any type of transparent, translucent, or opaque infill panel. The infill panel 102 may be made up of single or composite materials including, but not limited to, glass, polymer-based materials such as acrylic or polycarbonate. In one embodiment, the infill panel 102 may be a monolithic glazing panel of a single glass or laminated glass of any type or configuration. In another embodiment, the infill panel 102 may be an insulating glass unit with double or multi-layers of any type or configuration, including vacuum insulating glass panels. The infill panel 102 can be a clear, semi-transparent, or translucent infill panel. In other embodiments, the infill panel 102 may include monolithic, laminate, or multi-pane glazing panels of all kinds such as which may include smart glass coatings.

In certain embodiments, the infill panel 102 may incorporate one or a combination of glass films and/or coatings and interlayers of any type including, but not limited to, solar control films, polymer dispersed liquid crystal (PDLC) films, hard (pyrolytic) or soft (sputtered) glass coatings like metal oxide coatings, low-emissivity coatings, electrochromic coatings, thermochromic coatings, photovoltaic coatings, and the like.

### The Support Frame:

In certain embodiments, the members of the support frame 150 (and frames 250 and 350 discussed below) may be made up of an extruded metal, such as aluminum or stainless steel. In alternate embodiments, the members may be made up of a pultruded composite or extruded polymer-based material, such as fiberglass, vinyl, polyvinyl chloride (PVC), or unplasticized polyvinyl chloride (uPVC), for better thermal performance. In certain embodiments an additional metal piece or extrusion may be used with the composite or polymer-based profiles for better adhesive bonding and structural performance.

In some embodiments, support frame members, such as side jamb members 108 and 110 (see FIG. 2B) may have a plurality of openings. Certain openings are designed to engage a series of protrusions (not shown) which may assist in coupling the support frame 150 to an existing structure. In other embodiments, openings may be designed to reduce the overall weight of the support frame 150. In yet other embodiments, various components, such as electronic control components desiccant elements, or sensors may reside in compartments and/or spaces created by such openings or spaces within the support frame 150.

In certain embodiments, the support frame members may be shaped in cross-section to engage with other components, such as attachment or sealing mechanisms. For instance, in the illustrated embodiment of FIG. 2B, the side jamb members 108 and 110 define perimeter slots 130a and 130b for retaining continuous gaskets 132a and 132b, respectively.

In certain embodiments, the legs of corner keys (not shown) may be inserted into longitudinal receiving slots (not shown) formed at the ends of the individual members to join the individual members to together to produce an overall frame.

### Attachment Mechanisms:

A variety of attachment mechanisms may be used to removeably secure (i.e., non-destructively secure) the frame 150 (and frames 250 and 350) to the existing window frame elements, and in some embodiments, to the existing window panels. Such mechanisms include recloseable fastener strips, magnets, screws, clips, EPDM (“ethylene propylene diene monomer”) pressure fit gaskets, connector pieces (such as extruded aluminum), mechanical fasteners such as screws, or other components known in the art. For instance, one example of recloseable fastener strips is 3M Dual Lock® strips which will allow the secondary windows to be removed for cleaning and maintenance.

In yet in other embodiments forming a more permanent system (or for an exterior placement), a variety of other peripheral attachment (e.g., structural adhesives) may be used to couple the support frame 150 to the existing structure depending on the application. In one embodiment, a structural adhesive seal, such as Dowsil® structural silicone sealants, which may be applied in the field to the support members. Additionally, one or more double-sided peripheral adhesive tapes may be applied in the shop or in the field to define an area for the structural adhesive seal members in place as a means for temporary attachment until the structural adhesive seal may be fully cured and ready to carry the load of the assembled system.

In an alternate embodiment of a more permanent nature, a shop or field-applied double-sided structural adhesive tape, such as 3M® VHB tapes, may be used along with one or all of its associated double-sided adhesive tapes for attaching the supporting frame to the existing structure.

### Sealing Mechanisms:

Unwanted gaps between the frame 150 and existing window frame elements or glazing panels may be sealed with a variety of gaskets and sealants to a barrier to the passage of unwanted air flow and to force the air flow through the air permeable filters. Such gaskets may be rigid material, EPDM Rubber, extruded silicone rubber, or extruded vinyl rubber. Such sealing mechanisms may be produced in a variety of shapes and sizes as the situation dictates and as illustrated and described below.

### Air Permeable Filters:

For purposes of this disclosure, air permeable filters are open pore media which creates a passage for an air flow, but blocks dust and other airborne particulates. Such filters may be made from reticulated open cell foam, spun olefin fibers, and the like. In other embodiments, the filters may be positioned adjacent to or within the frame members. In yet other embodiments, the frame may include baffled slots or openings to allow air to pass in and out of the enclosed cavity and the baffles can filter dust and other airborne particulates.

### DESCRIPTION OF A FIRST EXEMPLARY EMBODIMENT

As discussed above, FIG. 2A is a vertical section drawing illustrating one exemplary embodiment of a breathable window retrofit system 100 mounted next to the existing head element 16 and the existing sill element 18 of the existing glazing system or window 12 described above. In certain embodiments, the glazing system 100 comprises the glazing infill panel 102 wherein the top portion of the panel 102 may be coupled to a support frame 150 via a perimeter glazing gasket 118 which couples to the perimeter of the panel 102 and is designed to fit within an engaging or U-shaped retaining slot formed by the support frame members, such as the head profile member 104 as illustrated in FIG. 2A.

In certain embodiments, the support frame 150 comprises a head profile member 104, a sill profile member 106, a first side jamb member 108 (see FIG. 2B) and a second side jamb member 110 (FIG. 2B).

In the illustrated embodiment, the side jamb members 108 and 110 define perimeter slots 130a and 130b for retaining continuous gaskets 132a and 132b, respectively (see FIG. 2B).

As illustrated in FIG. 2A, in certain embodiments, the head profile member 104 of the panel frame 150 may engage an optional retaining member, such as a downward facing head channel 120. In other embodiments, an angle or another type of retaining member may be used to retain the head profile member 104 during installation and in case of a failure of the primary attachment means. In the illustrative embodiment, the head channel 120 couples to the existing head jamb element 16 via an adhesive means, such as adhesive tape 112. As illustrated, the head channel 120 encloses a portion of the head profile member 104 and also encloses an upper air permeable filter 122 which may allow the exchange of air to address condensation or other thermal and moisture problems.

In certain embodiments, there may be a lower air permeable filter 124 coupled to the sill profile member 106. The lower air permeable filter 124 is designed to allow the exchange of air between the cavity 126 and the lower edge of the sill profile member 106 (between a plurality of non-continuous shims or supports 128 designed to support the support bottom of the frame 150).

FIG. 2B is a horizontal section drawing illustrating the breathable window retrofit system 100 positioned next to the existing side jamb elements 20 and 22. In certain embodiments, side slots 130a and 130b formed within the exterior facing surface of the side jamb members 108 and 110 engage continuous side gaskets 132a and 132b to form a seal between the existing side jamb elements 20 and 20 and the side jamb members 110 and 108 of the support frame 150. In certain embodiments, the support frame 150 may be mounted to existing infill panel 12 or window frame elements 36a and 36b in a non-intrusive and non-destructive additive method, such as with recloseable 3M Dual Lock™ mounting strips 134a and 134b.

### DESCRIPTION OF A SECOND EXEMPLARY EMBODIMENT

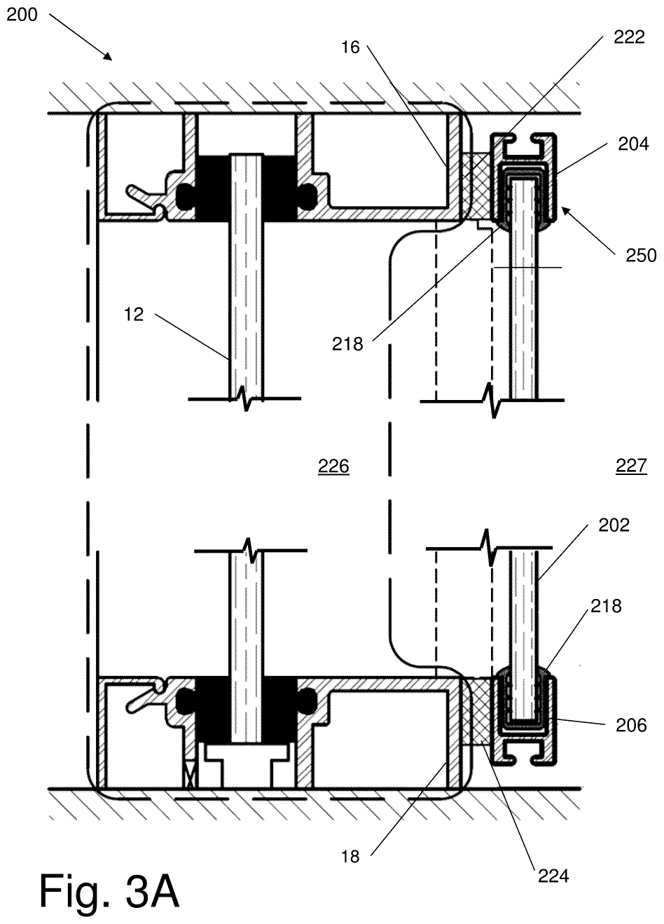

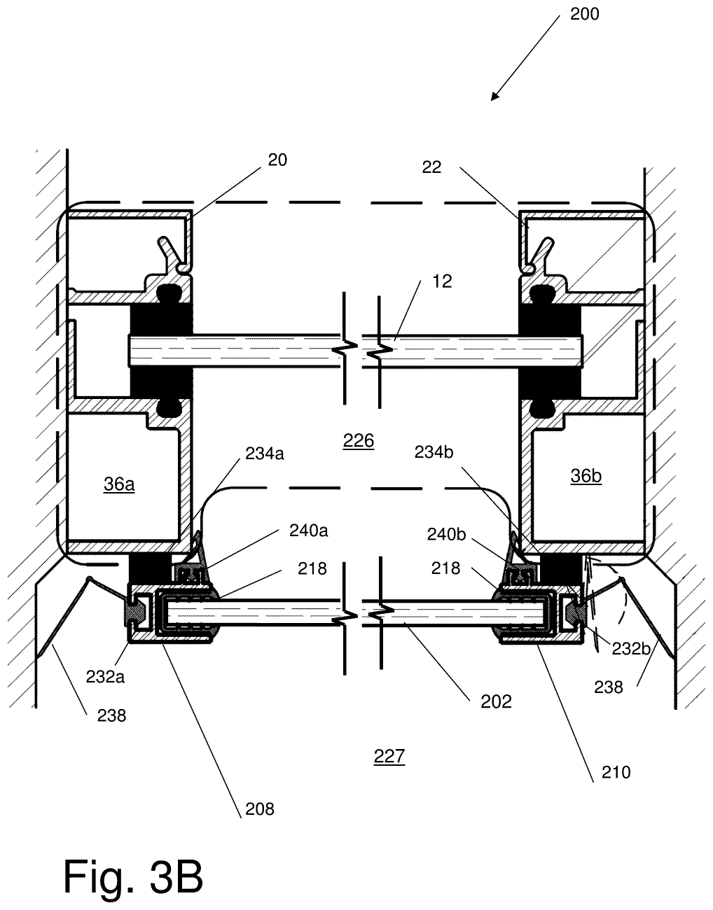

A second exemplary embodiment is illustrated in FIGS. 3A and 3B. The second embodiment is similar to the embodiment discussed in reference to FIGS. 2A and 2B above except the second embodiment couples directly to frame assemblies 32a, 32b, 36a, and 36b without the use of an optional head channel 120 discussed in reference with FIG. 2A.

For brevity and clarity, a description of those parts which are identical or similar to those described in connection with the first embodiment illustrated in FIGS. 2A and 2B will not be repeated here. Reference should be made to the foregoing paragraphs with the following description to arrive at a complete understanding of this second embodiment. Furthermore, any element discussed above may be combined with the embodiment discussed with reference to FIGS. 3A and 3B and such a combination would still be within the scope of the claimed invention.

FIG. 3A is a vertical section drawing illustrating one embodiment of a breathable window retrofit system 200 mounted next to the existing head element 16 and the existing sill element 18 of the existing glazing system or window 12 described above. FIG. 3B is a horizontal section drawing illustrating the breathable window retrofit system 200 positioned next to the existing side jamb elements 20 and 22.

In certain embodiments, the glazing system 200 comprises a panel or glass infill 202 wherein the top portion of the panel 202 may be coupled to a head profile member 204 via a perimeter glazing gasket 218 which couples to the perimeter of the panel 202 and is designed to fit within an engaging slot or indent formed by the support frame members, such as the support frame 250 as illustrated in FIGS. 3A and 3B.

In certain embodiments, the support frame 250 comprises a head profile member 204, a sill profile member 206, a first side jamb member 208 (see FIG. 3B) and a second side jamb member 210 (FIG. 3B).

As illustrated in FIGS. 3A and 3B, in certain embodiments, the support frame 250 couples to the existing window frame elements via an attachment means, such as recloseable strips 234a and 234b, as discussed above.

In certain embodiments, there may be an upper air permeable filter 222 coupled to the head profile member 204. The upper air permeable filter 222 is designed to allow the exchange of air between the space 226 and the exterior space 227. Similarly, in certain embodiments, there may be a lower air permeable filter 224 coupled to the sill profile member 206. The lower air permeable filter 224 is designed to allow the exchange of air between the space 226 and the lower edge of the sill profile member 206 (or in some embodiments, between a plurality of non-continuous shims or supports (not shown) which are designed to support the frame 250).

As illustrated in FIG. 3B, in certain embodiments, there may be one or more air sealing gaskets 240a and 240b positioned between the side jamb members 208 and 210 and the existing side jamb elements 20 and 22 to form a seal between the existing side jamb elements 20 and 22 and the side jamb members 210 and 208 of the frame 250. In certain embodiments, the frame 250 may be mounted to existing window frame elements 36a and 36b in a non-intrusive and non-destructive additive method as described above.

Optionally, in certain embodiments, there may be a cosmetic gasket or seal 238 coupled to perimeter slots 232a and 232b of the side jamb members 208 and 210, respectively. The cosmetic gasket 238 is designed to conceal any gap between the secondary window system 200 and the adjacent existing building materials. In certain embodiments, the cosmetic gasket 238 may be formed from the same materials as a sealing gasket, including EPDM rubber.

### Description of a Third Exemplary Embodiment

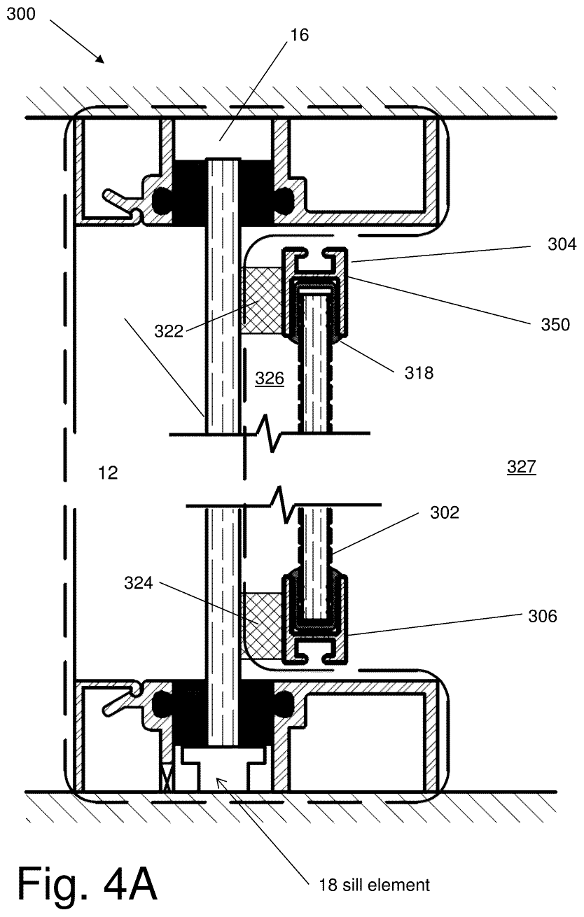

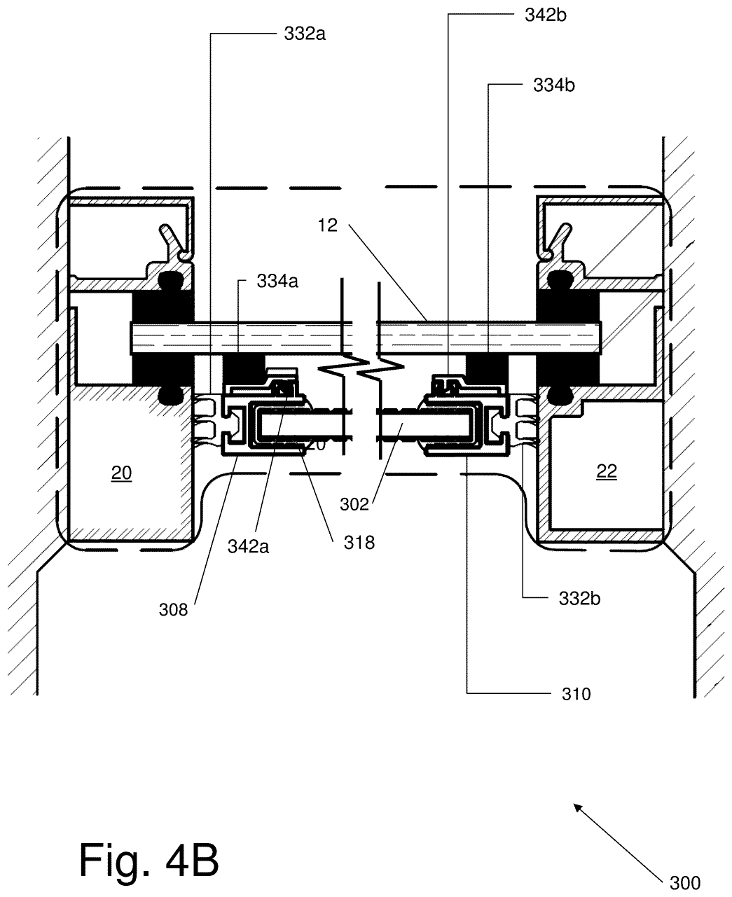

A third exemplary embodiment is illustrated in FIGS. 4A and 4B. The third embodiment is similar to the embodiments discussed above except the third embodiment couples directly to the existing infill panel 12 without directly coupling to the existing window frame elements as discussed above.

For brevity and clarity, a description of those parts which are identical or similar to those described in connection with the first embodiment illustrated in FIGS. 3A and 3B will not be repeated here. Reference should be made to the foregoing paragraphs with the following description to arrive at a complete understanding of this second embodiment. Furthermore, any element discussed above may be combined with the embodiment discussed with reference to FIGS. 4A and 4B and such a combination would still be within the scope of the claimed invention.

FIG. 4A is a vertical section drawing illustrating one embodiment of a breathable window retrofit system 300 mounted next to the existing infill panel 12 of the existing glazing system described above. FIG. 4B is a horizontal section drawing illustrating the breathable window retrofit system 300 positioned next to the existing infill panel 12.

In certain embodiments, the glazing system 300 comprises a panel or glass infill 302 wherein the top portion of the panel 302 may be coupled to a head profile member 304 via a perimeter glazing gasket 318 which couples to the perimeter of the panel 302 and is designed to fit within an engaging slot formed by the support frame members, such as the support frame 350 as illustrated in FIGS. 4A and 4B.

In certain embodiments, the support frame 350 comprises a head profile member 304, a sill profile member 306, a first side jamb member 308 (see FIG. 4B) and a second side jamb member 310 (FIG. 4B).

As illustrated in FIGS. 4A-4B, in certain embodiments, the support frame 350 couples to the existing infill panel 12 via an attachment means, such as reclosable fastening strips 334a and 334b (FIG. 4B), as discussed above.

In certain embodiments, there may be an upper air permeable filter 322 coupled to the head profile member 304. The upper air permeable filter 322 is designed to allow the exchange of air between the space 326 and the exterior space 327. Similarly, in certain embodiments, there may be a lower air permeable filter 324 coupled to the sill profile member 306. The lower air permeable filter 324 is designed to allow the exchange of air between the space 326 and the exterior space 327 (between a plurality of non-continuous shims (not shown) which are designed to support the support frame 350).

In certain embodiments, there may be one or more air sealing gaskets 332a, 332b positioned between the side jamb members 308 and 310 and the existing side jamb elements 20 and 22 to form a seal between the existing side jamb elements 20 and 20 and the side jamb members 310 and 308 of the support frame 350. In certain embodiments, the support frame 350 may be mounted to existing window panel 12 in a non-intrusive and non-destructive additive method as described above with recloseable strips 334a and 334b.

In certain embodiments, there may be polymeric spacers 342a and 342b positioned between the reclosable fastening strips 334a and 334b and the jamb members 308 and 310 as illustrated in FIG. 4B.

### Exemplary Installation Method

The breathable window retrofit system 100 can be mounted on either the exterior or the interior side of an existing glazing system, but the preferred method is on the interior side of an existing system. In certain embodiments, one or more support frames 150 may be attached to clean existing infill panels 12 of the existing glazing system. In an alternate embodiment, the support frame 150 may be attached to the framework (e.g., head element 16, sill element 18, jamb elements 20 and 22) of the existing glazing system. In certain embodiments, structural adhesives, adhesive tapes, or recloseable mounting strips may be applied to clean surfaces of a framework surrounding an existing infill panel. In such embodiments, the framework surrounding an existing infill panel can be considered a peripheral area of the infill panel and part of the infill panel itself for purposes of this disclosure and claims.

In certain embodiments, the support frame 150 may be installed in pieces or in multiple smaller assemblies that are either assembled on site or pre-assembled in a shop or a fabrication facility. In an alternate embodiment, the support frame 150 may be installed in one piece as a unit that is either assembled on site or pre-assembled in a shop or a fabrication facility.

In some situations, additional framing member may have to be installed around the existing window. In such situations the secondary window systems would attach directly to these additional framing members similarly to what is shown if FIGS. 3A through 4B.

In sum, in some embodiments the installation method comprises positioning a frame as described above enclosing a perimeter of a secondary glazing panel adjacent to an existing glazing panel to form an interior cavity between the existing glazing panel and the secondary glazing panel, and positioning at least one air permeable filter adjacent to the interior cavity to allow an air flow between the interior cavity and an exterior space adjacent to the secondary glazing panel.

Other embodiments of the method described above may also comprise positioning a second air permeable filter adjacent to the interior cavity to allow a second air flow between the interior cavity and the exterior space adjacent to the secondary glazing panel.

Other embodiments of the method described above may also comprise positioning the at least one air permeable filter in proximity with a bottom of the frame and positioning a second air permeable filter in proximity with a top of the frame.

Other embodiments of the method described above may also comprise coupling the at least one air permeable filter to a sill element of the frame and coupling a second air permeable filter to a header element of the frame.

Other embodiments of the method described above may also comprise coupling at least one retainer to an existing window frame element to partially retain at least one frame member of the frame.

Other embodiments of the method described above may also comprise sealing at least one air gap between existing window frame elements and the frame so that the air flow occurs through the at least one air permeable filter.

Other embodiments of the method described above may also comprise sealing at least one air gap between the existing glazing panel and the secondary glazing panel so that the air flow occurs through the at least one air permeable filter.

Other embodiments of the method described above may also comprise sealing a cosmetic gasket to at least one frame member of the frame.

Other embodiments of the method described above may also comprise attaching at least one frame member of the frame to an interior facing surface of an existing window frame element.

Other embodiments of the method described above may also comprise attaching at least one frame member of the frame to an interior facing surface the existing infill panel.

Other embodiments of the method described above includes mounting one strip of a pair of reclosable mounting strips to the outside facing surface of the frame and a mounting a matching mounting strip to the inside facing surface of an existing window frame element.

Other embodiments of the method described above includes mounting one strip of a pair of reclosable mounting strips to the outside facing surface of the frame and a mounting a matching mounting strip to the inside facing surface of an existing infill panel.

Other embodiments of the method described above may also comprise positioning a gasket around the perimeter of the frame to create a frictional retainage between the frame and the surrounding window elements.

Other embodiments of the method described above may also comprise flexibly attaching the frame so not to limit thermal expansion of the separate members of the system.

Other embodiments of the method described above may also comprise positioning intermediate framing members in proximity to a perimeter of the existing window and attaching the frame to the intermediate framing members.

### Smart Systems:

It should be noted that while the embodiments are described as a retrofit system to be used with existing window systems, those skilled in the art will appreciate that these embodiments, or the breathable window retrofit parts thereof, may also be provided as integral parts of improved new or smart glazing systems. For example, the system 100 and its associated mounting mechanism may include new glass technology such as coatings, sensors, and photovoltaics.

In certain embodiments, the infill panels 102, 202, or 302 may be a monolithic glazing panel of two or more panes, such as proximal or outer pane and distal or inner pane. The panes may include glass or polymer-based substrates, and may be laminated using one or more interlayers, such as Polyvinyl Butyral (PVB). In certain embodiments, the infill panels 102, 202, or 302 may incorporate one or more photovoltaic (PV) cells or cell systems. As used in this disclosure, the term “cell” may incorporate one or more films and/or coatings known in the industry which essentially operate similar to solar cells. For instance, as used in this th disclosure, the term PV cell may include transparent/substantially-clear PV coatings, such as SolarWindow® PV coatings or Ubiquitous Energy® wavelength-selective PV coatings, or it may include a multilayer amalgamation of several layers or coatings to transform light to electrical voltage as is well known in the art. In certain embodiments, the PV cell may be applied to one of the panes of the infill panels, such as on a distal surface of the outer pane.

Additionally, the infill panels 102, 202, or 302 may incorporate one or more electrochromic (EC) layers or layer systems. Used in this disclosure, the term “layer” may include one or more films and/or coating layers, which may be conductive layers that have light transmissivity that is variable in response to an electrical current, such as View Glass® or SageGlass@ electrochromic coatings. The EC layer may be applied to one of the other panes of the infill panels 102, 202, or 302, such as on the proximal surface of the inner pane. Additional coatings and/or films may also be incorporated between the layers of the infill panel 102, 202, or 302 and/or applied on the proximal surface of the outer pane or the distal surface of the inner pane.

The PV cell(s) may incorporate one or more transparent electrodes that connect the photovoltaic coating layer(s) to a control system described below using wire(s) or leads that go through one or more notches in the side profile members of the frames 150, 250, or 350. Additionally, the EC layer(s) may incorporate one or more electrical connections (not shown), such as busbars, that connect the electrochromic coating layer(s) to a control system using wire(s) that go through one or more notches in the side profile members of the frames 150, 250, and/or 350.

In one embodiment, the frames 150, 250, and 350 may also incorporate a light source, such as linear light-emitting diode (LED) lighting strip that may be connected to the control system using wire(s) that go through the notches in the side profile members of the frames 150, 250, and 350.

In one embodiment, the control system and an energy storage device, such as a battery, in communication with the control system may be attached to a side profile member of the frames 150, 250, 350 (or the existing window frame elements) using, for example, a double-sided adhesive tape and located so that it fits inside an opening in a cavity defined by a side rail member of the frames 150, 250, 350.

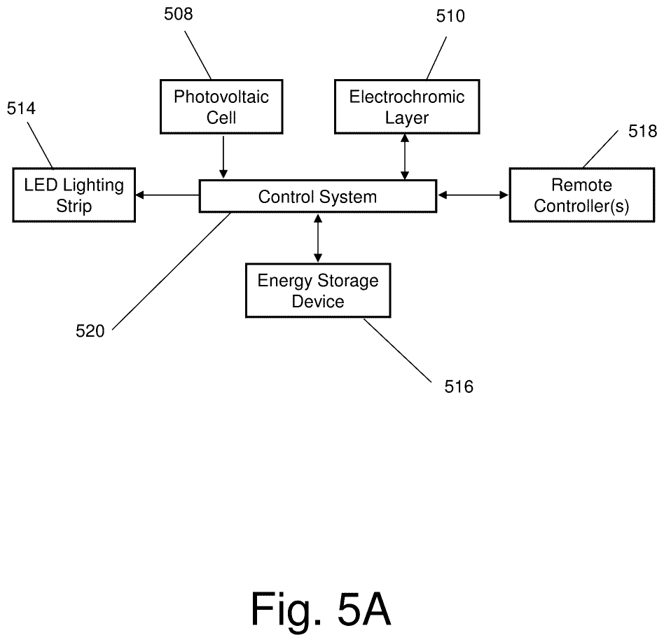

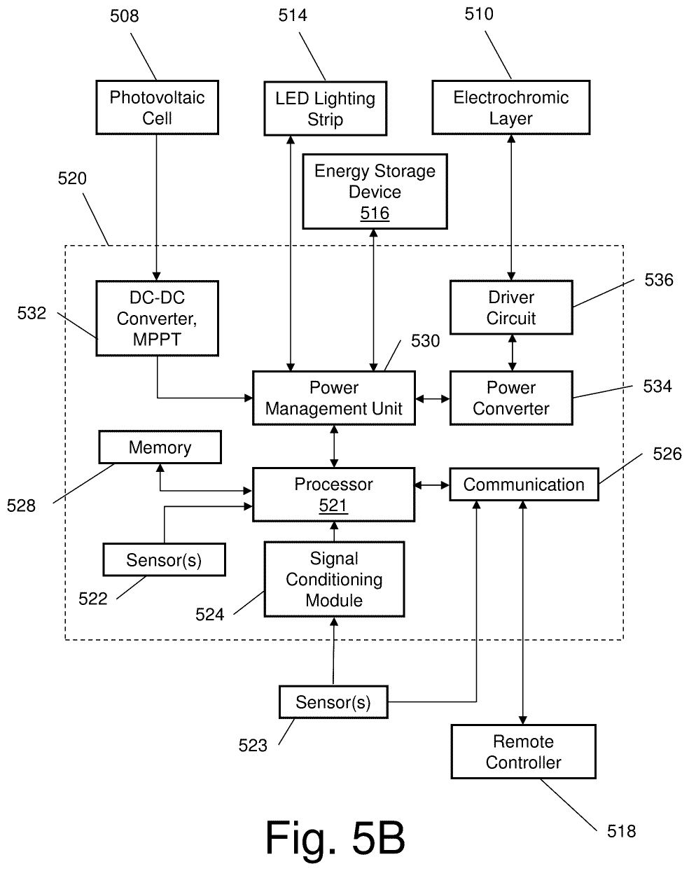

FIG. 5A is a functional diagram of one smart embodiment that may be included in the system 100, which includes the control system 520. As illustrated in FIG. 5A, the control system 520 may be in communication with the PV cell(s) 508, the EC layer(s) 510, the LED lighting strip(s) 514, and the energy storage device 516.

FIG. 5B is a functional diagram of one embodiment of the control system 520. In certain embodiments, the control system 520 may include one or more circuit boards, cards, or chips that may incorporate one or more microcontrollers/processors 521 that include appropriate logic (in a memory 528—See FIG. 5B) for performing one or more power and/or communication control functions, possibly combined in one single circuit board, card, or chip. Additionally, the control system 520 may include a power management unit 530 that direct the electrical energy generated by the PV cell(s) 508 to either charge the energy storage device 516 for later use and/or directly supply current to control/power built-in electronics, devices, and/or systems including but not limited to, the control system 520, the EC layer(s) 510, and the LED lighting strip 514.

In certain embodiments, the control system 520 may also incorporate boost/DC-DC converters 532 to step up the voltage of the direct current (DC) that is provided by the PV cell(s) 508 to a suitable level for utilization within the system, which may include a maximum power point tracking (MPPT) to maximize power extraction from the PV cell(s) 508 under all conditions. The control system 520 may also incorporate a power converter 534 to convert a low voltage to the power requirements of the EC layer(s) 510 and one or more driver circuits 536 to feed the power to the EC layer(s) 510.

In certain embodiments, the control system 520 may also incorporate one or more communication units 526 that are in communication with the processor(s) 521 and are used for receiving and sending commands wirelessly to and from the control system 520 and one or more remote controllers 518, such as a user interface and/or a building automation system. A computer readable medium such as the memory 528 in communication with the processor(s) 521 may be used to store such commands and to store other system information about the glazing panel 102 in a configuration file. In certain embodiments, there may also be a radio frequency identification tag (RFID) incorporating system information in a configuration file. The communications unit(s) 526 may incorporate a radio for wireless controls, such as RF and/or IR, as well as wireless communication such as Bluetooth, WiFi, Zigbee, EnOcean and the like to send instructions to the processor(s) 521 and to send data out to a building automation system, for example.

The control system 520 may also incorporate one or more onboard sensors 522, such as thermal sensors, in communication with the processor(s) 521. Additionally, the control system 520 may be in communication with one or more remote and/or frame-incorporated sensors 523, such as optical sensors, through a signal conditioning module 524 and/or through the communication unit(s) 526.

In certain embodiments, output from the remote controller(s) 518 or the sensor(s) 523 to the control system 520 determines a tint level of the EC layer(s) 510, based on various information from the configuration file in the memory 528. The processor(s) 521 may then instruct the power management unit 530 to apply a voltage and/or current to the EC layer(s) 510 to transition to the desired tint level. In certain embodiments, the control system 520 may also be configured to have a user interface, for example when automation is not required, so that it can function as an I/O controller for an end user where, for example, a keypad or other user-controlled interface is available to the end user to control the EC layer(s) functions and/or other functions related to other built-in devices/systems in the secondary window system.

In yet other embodiments, the control system 520 may incorporate one or more wireless power transmitters and/or receivers for wireless power functions, which can be used to power one or more electronic devices and/or systems within the retrofit window system or transmit power generated by the PV cell(s) 508 for use with other devices in close proximity to the retrofit window system. Wireless power transmission includes, for example but not limited to, induction, resonance induction, radio frequency power transfer, microwave power transfer and laser power transfer. It should be noted that while the embodiments are described as a retrofit system to be used with existing glazing systems, those skilled in the art will appreciate that these embodiments, or the breathable window retrofit parts thereof, may also be provided as integral parts of improved new or replacement glazing systems.

### Advantages of Certain Embodiments:

Certain exemplary embodiments are a breathable secondary window retrofit (SWR) system and may be installed on the inside of existing windows. The various embodiments may be produced with an ultra-slim profile and various colors so as to fit within the various color and decorating schemes of existing buildings.

The use of certain embodiments may reduce dust and heat build-up that may cause thermal stress breakage and fogging or condensation problems. Furthermore, certain embodiments may significantly reduce energy consumption and peak heating/cooling loads. The systems can be tailored to a variety of existing window conditions and can be installed quickly and cleanly from the interior of buildings without damage to existing windows or structures. Such embodiments are scalable for commercial buildings and may be installed for a full façade retrofit or for individual tenants or tenant fit out.

The foregoing description of the embodiments of the invention has been presented for the purposes of illustration and description. It is not intended to be exhaustive or to limit the invention to the precise form disclosed. Many combinations, modifications and variations are possible in light of the above teaching. For instance, in certain embodiments, each of the above-described components and features described in reference to one embodiment may be individually or sequentially combined with other components or features of other embodiments and still be within the scope of the present invention. The components of the various embodiments largely interchangeable. Consequently, undescribed embodiments which have interchanged components are still within the scope of the present invention. It is intended that the scope of the invention be limited not by this detailed description, but rather by the claims.

1. A breathable system for retrofitting an existing window, comprising:
a secondary infill glazing panel adapted to be positioned adjacent to an existing glazing panel to form an interior cavity between the existing glazing panel and the secondary glazing panel,
a frame enclosing exterior edges of the secondary infill panel, and
at least one air permeable filter coupled to the frame adapted to allow an air flow between the interior cavity and an exterior space adjacent to the secondary glazing panel.

2. The system of claim 1, wherein the frame comprises a plurality of frame members forming a U-shaped retaining slot for retaining a perimeter portion of the edge of the secondary infill panel.

3. The system of claim 1, wherein a dimension of the frame is sized to allow the air flow from the interior cavity through the at least one air permeable filter to the exterior air space.

4. The system of claim 1, wherein the frame comprises a plurality of frame members each having longitudinal engagement slots to receive a leg of a corner key which is used to partially join the frame members together to form the frame.

5. The system of claim 1, further comprising a second air permeable filter coupled to the frame to allow a second air flow between the interior cavity and the exterior space adjacent to the secondary glazing panel.

6. The system of claim 1, wherein the at least one air permeable filter is positioned through the frame.

7. The system of claim 1, wherein the at least one air permeable filter is positioned in proximity with a bottom of the frame and a second air permeable filter is positioned in proximity with a top of the frame.

8. The system of claim 1, wherein the at least one air permeable filter is coupled to a sill element of the frame and a second air permeable filter is coupled to a header element of the frame.

9. The system of claim 1, further comprising at least one retainer coupled to an existing window frame element which partially retains at least one frame member of the frame.

10. The system of claim 1, further comprising at least one retainer coupled to an existing window frame element enclosing the at least one air permeable filter and a portion of the frame.

11. The system of claim 1, further comprising a means for sealing at least one air gap between existing window frame elements and the frame so that the air flow occurs through the at least one air permeable filter.

12. The system of claim 1, further comprising a means for sealing at least one air gap between the existing glazing panel and the secondary glazing panel so that the air flow occurs through the at least one air permeable filter.

13. The system of claim 12, wherein the means for sealing is a gasket coupled to an indent defined in an outside facing surface of the frame.

14. The system of claim 1, further comprising a sealing gasket coupled to a frame member adapted to form a seal between the frame member and a corner of an existing window frame element.

15. The system of claim 1, wherein at least one frame member defines a perimeter slot for coupling to a cosmetic gasket.

16. The system of claim 1, further comprising at least one frame member defining a perimeter slot for coupling to a sealing gasket.

17. The system of claim 1, further comprising a means for attaching to an existing element which is positioned on an exterior facing surface of at least one frame member and adapted to adhere to an interior facing surface of an existing window frame.

18. The system of claim 1, further comprising a means for attaching to an existing element which is positioned on an exterior facing surface of at least one frame member and the means for attaching is adapted to adhere to an interior facing surface of the existing infill panel.

19. The system of claim 1, further comprising a means for attaching to an existing element which is positioned on an exterior facing surface of at least one polymeric spacer coupled to an exterior facing surface of a frame member and the means for attaching is adapted to adhere to an interior facing surface of an existing infill panel.

20. The system of claims 17-19 claim 17, wherein the means for attaching is a pair of reclosable mounting strips where one mounting strip is coupled to the exterior facing surface of the frame and a matching mounting strip is coupled to the interior facing surface of an existing window frame.

21. The system of claims 17-19 claim 17, wherein the means for attaching is a pair of reclosable mounting strips where one mounting strip is coupled to the exterior facing surface of the frame and a matching mounting strip is coupled to the interior facing surface of an existing window.

22. The system of claim 1, further comprising a means for attaching the frame to existing window frame elements, wherein the means for attaching is a gasket positioned around a perimeter of the frame and sized to create a frictional retainage between the frame and surrounding existing window elements.

23. The system of claim 1, comprising a means for attaching the frame to existing window frame elements or an existing glazing panel wherein the means for attaching is a flexible attachment system which does not limit thermal expansion of separate members of the system.

24. The system of claim 1, further comprising intermediate framing members positioned in proximity to a perimeter of the existing window and a means for attaching the frame to the intermediate framing members.

25-43. (canceled)
